(19) United States
(12) Patent Application Publication
(10) Pub. No.: US 2011/0202839 A1
(43) Pub. Date: Aug. 18, 2011

(54) CONFIGURABLE MULTILINGUAL KEYBOARD

(76) Inventors: Sulaiman AlKazi, Mishref (KW); Syed Kamal H. Jaffrey, Winchester, MA (US)

(21) Appl. No.: 13/029,993

(22) Filed: Feb. 17, 2011

Related U.S. Application Data
(60) Provisional application No. 61/305,731, filed on Feb. 18, 2010.

(51) Int. Cl. G06F 3/01

(52) U.S. Cl. 715/703

(57) ABSTRACT

Systems and methods for creating a configurable multi-language, research and application keyboard tool. A configurable keyboard system includes a font editor/generator for modifying and creating new characters, a language database for storing characters of one or more alphabets, a user interface for display outputs and accepting inputs from a user, and a layout generator for configuring a dynamic keyboard display and displaying the keyboard display on the user interface. Characters from one or more languages may be grouped in proximity to each other on the keyboard display based on common phonetic sounds.

### REFERENCE TO RELATED APPLICATION

This application claims the benefit of U.S. Provisional Patent Application No. 61/305,731, filed on Feb. 18, 2010, entitled “Multilingual Keyboard”, the disclosure of which is incorporated herein by reference in its entirety.

### FIELD OF INVENTION

This application generally relates to a linguistic input device and software. More particularly, this application relates to systems and methods for creating a reconfigurable multi-language, research and application keyboard tool.

### BACKGROUND

Language barriers between people from different regions around the world have long prevented communication and understanding of spoken and written words. Some aspects of the study of linguistics have attempted to resolve language barriers by studying the connections between the written alphabets of a language and the spoken sounds associated with the symbols and characters of the alphabet. Analysis of the sounds and the symbols representative of those sounds has been directed towards the creation of a universal alphabet that encapsulates the finite sounds of which the human voice is capable of making A further obstacle is mapping or associating these new characters and symbols to the individual languages so that the universal language can be taught and understood by those who study it. A new alphabet is inadequate if it is not mapped to another language so that the new alphabet can be learned in the context of the pre-existing language by comparison of words and phrases. Studying linguistics or languages is further hampered by traditional and archaic single-language computer input devices, such as the traditional keyboard.

Traditional input devices for personal computers, personal digital assistants (“PDAs”) and other electronic devices consist of a fixed set of physical keys hard-coded to input one or more predefined characters. One of the most prevalent input devices is a QWERTY style keyboard, so-named by the first six characters on the keys in the upper-left hand portion of the keyboard. The arrangement of characters on the keys of the QWERTY keyboard was designed to avoid typebar collisions using an up-stroke typewriter. Due to the mechanical restrictions of such a machine, frequently used symbols and characters often typed in succession were not to be located near one another since rapid pressing of the keys caused the mechanical typebars to collide and jam the typewriter.

As technology has advanced, and as mechanical typewriters have become nearly obsolete, the QWERTY arrangement provides no advantage in ergonomics, efficiency or otherwise. To beginning typists, it can be an inefficient and confusing configuration to learn. The QWERTY configuration is still dominant today because of its wide-spread adoption by those who can already type and the lack of alternatives to those who are just learning.

For example, FIG. 1 depicts a traditional QWERTY English-language keyboard. In addition to the arrangement of the keys, traditional keyboards have to rely on overlapping functionality for many keys. For example, each of the numeral keys includes a secondary character that is activated by simultaneously pressing the SHIFT key. The traditional keyboard is constrained by its size and its layout. While it would be easier and more efficient to type having only to press one key, not two at the same time, such a keyboard would be unwieldy and large.

Furthermore, while the Roman alphabet contains twenty-six base letters, ten cardinal numbers and a finite set of other characters and symbols, other languages may have hundreds of characters and symbols and some may have more. Typists required to type in multiple languages or mixed-language environments face difficulties in efficiently and effectively typing.

Another limitation that traditional input devices face is the lack of multi-language capability or support. While a number of languages are based on a similar base alphabet, every language differs by use of diacritics, or accents, to differentiate the pronunciation of a given character. As shown in FIG. 1, there are no keys dedicated to letters or characters with diacritics on a traditional QWERTY keyboard. In many operating systems a cumbersome sequence of keystrokes is required to type a letter having a diacritic. For example, in the common Microsoft Windows and Microsoft Word environments, to type the letter ‘é’ with an accent requires the following keystrokes: pressing the CTRL key simultaneously with the single quotation key, followed by the ‘e’ key. The sequence is awkward and time-consuming. The sequence for non-Roman alphabet characters and symbols is even more cumbersome. For example, inserting an Arabic or Chinese character requires accessing a pull-down menu to display a table of various symbols and characters. The typist must then search the table for the desired character and insert it into the text from the table. Typing words or phrases using this symbol table is time-consuming and inefficient.

Languages which are not based on the Roman alphabet, present significant difficulties when using a QWERTY keyboard. Such languages rarely have a one-to-one correspondence of characters across the language. Similarly to diacritics and special characters using a QWERTY keyboard, the user must go through a series of dropdown menus, searching a table of symbols and inserting the symbol into the text. Typing words or phrases consisting of multiple characters is time consuming, inefficient and frustrating to the user.

FIGS. 2 and 3 depict example layouts of an Arabic language keyboard and a Chinese language keyboard, respectively. The Arabic and Chinese layouts somewhat resemble the English QWERTY keyboard, however due to the complexities of the languages and differing alphabets, many of the keys have a primary, secondary and tertiary functionality. While these layouts do include the Roman alphabetic characters, they do not include other languages alphabets (i.e., typing in Arabic on the Chinese keyboard layout is just as difficult), nor do they include characters having diacritics. These traditional keyboard layouts have a fixed mapping of the keys to a character. While some modern keyboards allow users to re-configure the functionality of a portion of the keys, the majority of the keys are fixed.

### SUMMARY OF THE INVENTION

In view of the foregoing, it would be desirable to provide a user with the option to create customized layouts of a keyboard to increase typing efficiency, and to allow for seamless switching between different languages, fonts and configurations. Additionally, it would be desirable to provide a keyboard that serves as an adaptable and dynamic research and application tool capable of coupling languages through acoustics and phonics.

It is an object of the present disclosure to provide an application tool for research and other uses including a multilingual dynamic keyboard without fixed physical keys. The multilingual keyboard application tool allows for the creation of new characters and symbols and the arrangement of an alphabet into an efficient and instinctive configuration to learn and type multiple languages. The keyboard may include a touch-sensitive display having an interface with a plurality of configurable keys and a selector to select a keyboard configuration. The selection of a new configuration may display multiple alphabets across multiple rows presenting a new keyboard configuration having as many keys as necessary to represent the chosen languages.

According to one embodiment of the disclosure, a dynamic multi-language keyboard includes reconfigurable key-mappings and a choice of several languages that can be changed in real-time without reconfiguring the operating system or word processing program. A touch-sensitive display presents a digital keyboard layout that can be customized by the typist to provide a keyboard configuration that is the most efficient, logical and intuitive to the typist. Pressing on the touch screen where the key is displayed sends the character displayed on the key to the processor and is then displayed on the typist's primary display. A drop-down menu, or other type of menu, is shown on the digital keyboard screen allowing the typist to select another language thereby seamlessly transforming the keyboard display to another language's alphabet.

According to an embodiment a user interactive touch-screen keyboard device includes a plurality of icons in a plurality of rows and columns, a plurality of characters from at least two user-selected languages in which the plurality of characters from the at least two user-selected languages are assigned to the plurality of icons in respective ones of the plurality of rows in a first order characteristic of the respective language. The user interactive touch-screen keyboard device may also include a user controlled processor for creating a reordering of the characters of at least one said language for grouping characters of at least two languages according to a desired grouping methodology. In certain aspects the interactive touch-screen keyboard device includes a multi-layer system for displaying the at least two user-selected languages in at least two layers. In certain aspects, the at least two layers at least partially overlap. In certain aspects, one of the rows has characters defined by a user. In some aspects, the characters are modified from pre-existing characters by the user. In certain aspects, the characters are created as new characters by the user. In certain aspects, selecting a language places one or more characters of the selected language in the next available row. In certain aspects, selecting a language places one or more characters of the selected language in the next available column. The touch-screen keyboard device may further include a menu for selecting the at least two user-selected languages.

According to an embodiment, a configurable keyboard system includes a user interface for receiving inputs from a user, a language database for storing at least partial alphabets of at least two languages, a layout generator for generating a configurable keyboard for display on the user interface, in which the layout generator is responsive to user inputs for generating a phonetically grouped character representation of the alphabets of the at least two languages, and a processor configured to execute operating instructions for the user interface, layout generator, and the language database. In certain embodiments the configurable keyboard system further includes a font generator for generating and modifying at least one character. In some aspects, the user interface is a touch-sensitive device capable of receiving inputs and displaying outputs. In certain aspects, the configurable keyboard includes a plurality of icons corresponding to characters of the at least one alphabet. In some embodiments, the processor is further configured to receive a selection of an icon on the user interface, and display the character corresponding to the selected icon on a display. In certain aspects, the configurable keyboard is a graphical user interface.

According to an embodiment, a method for configuring a keyboard includes: accessing a menu including a list of languages, selecting a first language to be learned from the menu, assigning characters from the first language to one or more icons representing a keyboard, selecting a second language known to a user from the menu, and assigning characters of the second language automatically to one or more icons in phonetic proximity with corresponding phonetic characters of the first language. In certain embodiment, the method may include displaying the characters of the first and second languages in a keyboard display on a touch-sensitive device. In some embodiments the method further includes accessing a menu including a list of at least one keyboard configuration, selecting a keyboard configuration from the menu, reconfiguring the keyboard display in accordance with the selected keyboard configuration, and displaying the keyboard display on the touch-sensitive device. In certain aspects, assigning characters from the first language to the one or more icons representing a keyboard includes assigning the characters from the first language to a first row of the keyboard display. In certain embodiments the method includes generating at least one user-defined character, wherein the user defined character is accessed from the menu.

According to an embodiment, a method for configuring a keyboard for improved language learning presentation includes: accessing a menu including a list of languages, selecting a first language to be learned from the menu, assigning characters of the first language to icons representing a keyboard, selecting a second language known to a user from the menu, and selecting characters of the second language automatically in phonetic proximity with corresponding phonetic characters of the first language.

According to an embodiment, a touch-screen keyboard device includes a plurality of icons in a plurality of rows, a plurality of characters from at least two user-selected languages in which the plurality of characters are associated with the plurality of icons in a user selected representation, the representation comprising characters from both languages, and a user controlled menu for selecting the language combination.

According to an embodiment, a configurable keyboard device includes: means for receiving at least one input from a user, means for storing at least partial alphabets of at least two languages, and means for displaying a configurable keyboard layout including the alphabets of the at least two languages in response to the at least one input.

According to an embodiment, a touch-screen keyboard system includes a processor for implementing a sequence of instructions stored on a computer readable medium and configured to perform the steps of (a) receiving a user input for selecting a plurality of characters from at least two languages, (b) grouping the plurality of characters according to a grouping methodology, and (c) displaying the plurality of characters on a touch screen. In certain embodiments, the process is further configured to receive a user-selection of at least one of the plurality of characters on the touch screen, and display the selected character on a primary display.

### BRIEF DESCRIPTION OF THE DRAWINGS

The detailed description below of certain illustrative embodiments of the present disclosure refers to the accompanying drawings, of which:

FIG. 1 is an illustration of a traditional QWERTY keyboard;

FIG. 2 is an illustration of a traditional Arabic language keyboard;

FIG. 3 is an illustration of a traditional Chinese language keyboard;

FIG. 4 is a block diagram of a computing system, according to an illustrative embodiment;

FIG. 5 is a block diagram of the components of a configurable keyboard system, according to an illustrative embodiment;

FIG. 6 shows an example of edited font, according to an illustrative embodiment;

FIG. 7 shows a dynamic keyboard display layout, according to an illustrative embodiment;

FIG. 8 shows a flow chart for configuring a keyboard display layout, according to an illustrative embodiment;

FIG. 9 shows another dynamic keyboard display layout, according to an illustrative embodiment;

FIG. 10 shows another dynamic keyboard display layout, according to an illustrative embodiment;

FIG. 11 shows a flow chart for mapping a universal alphabet, according to an illustrative embodiment;

FIG. 12 shows a personal computer with a touch-sensitive dynamic keyboard and a primary display, according to an illustrative embodiment.

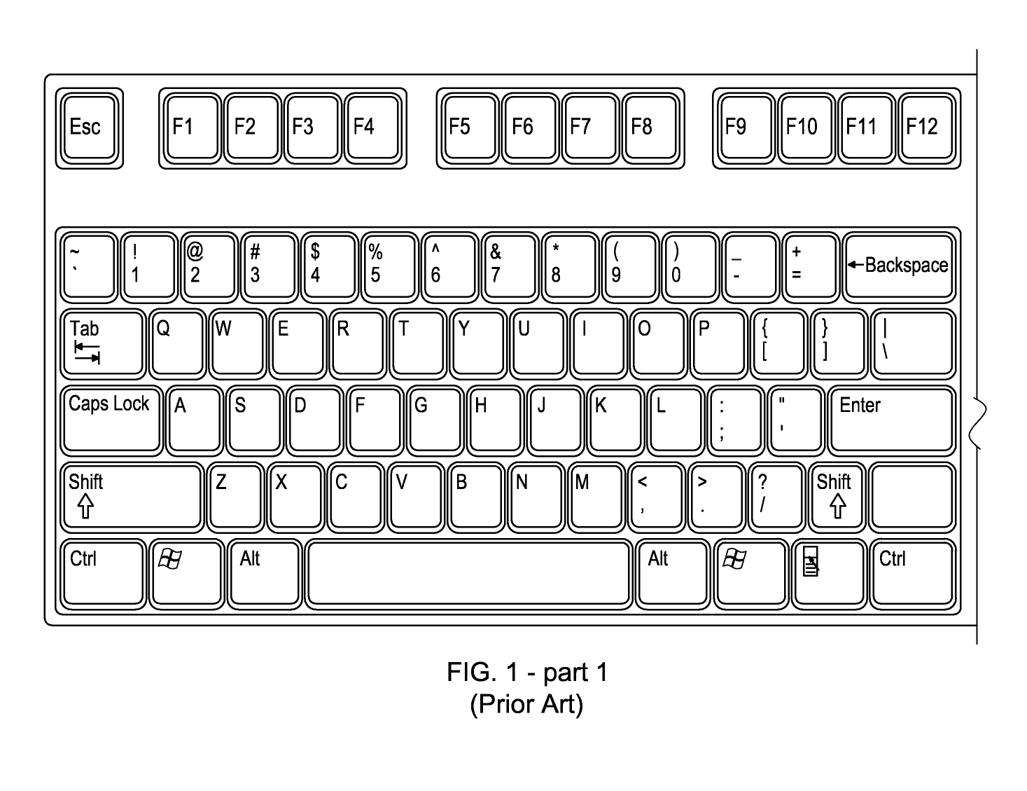

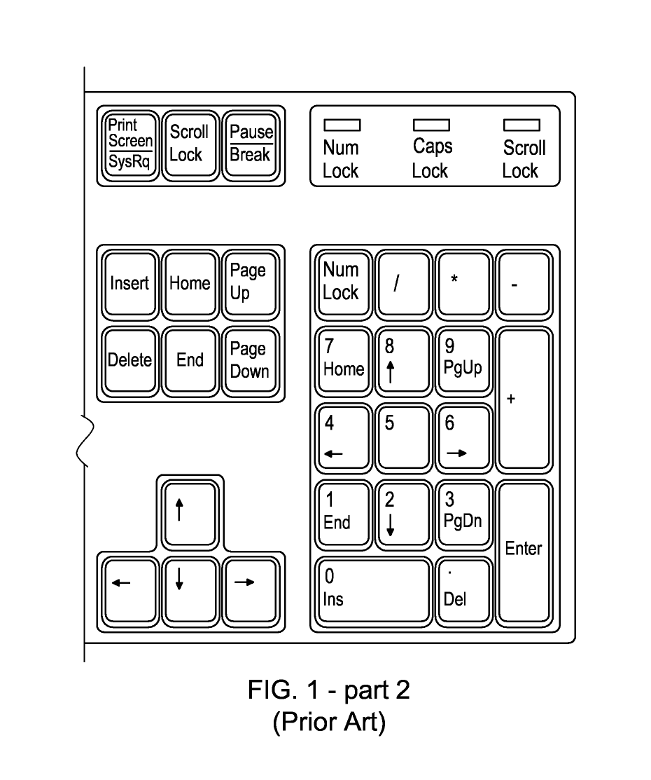

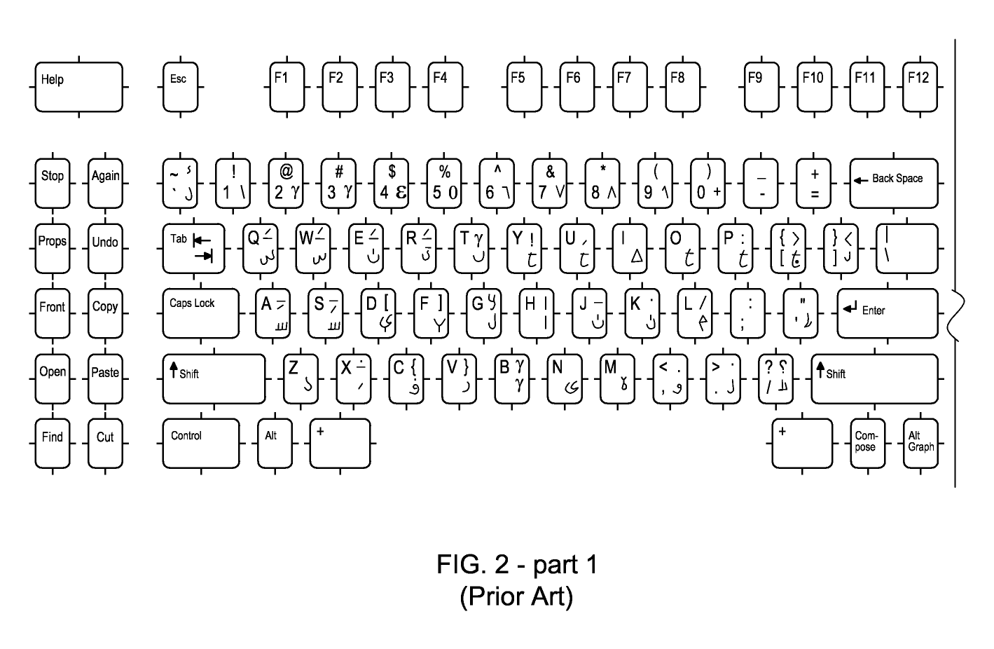

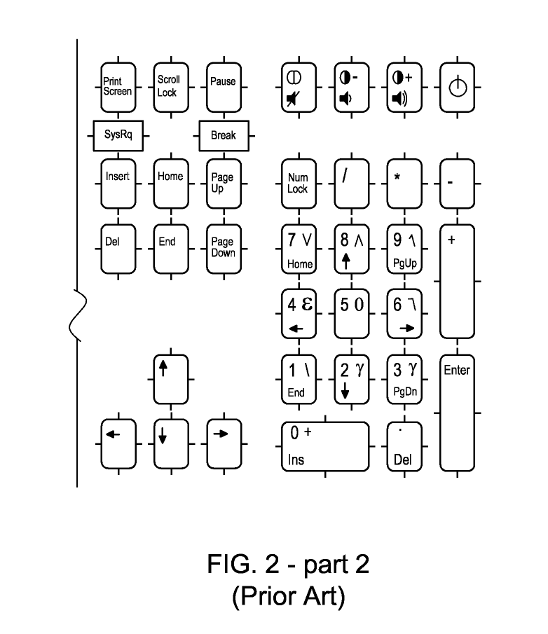

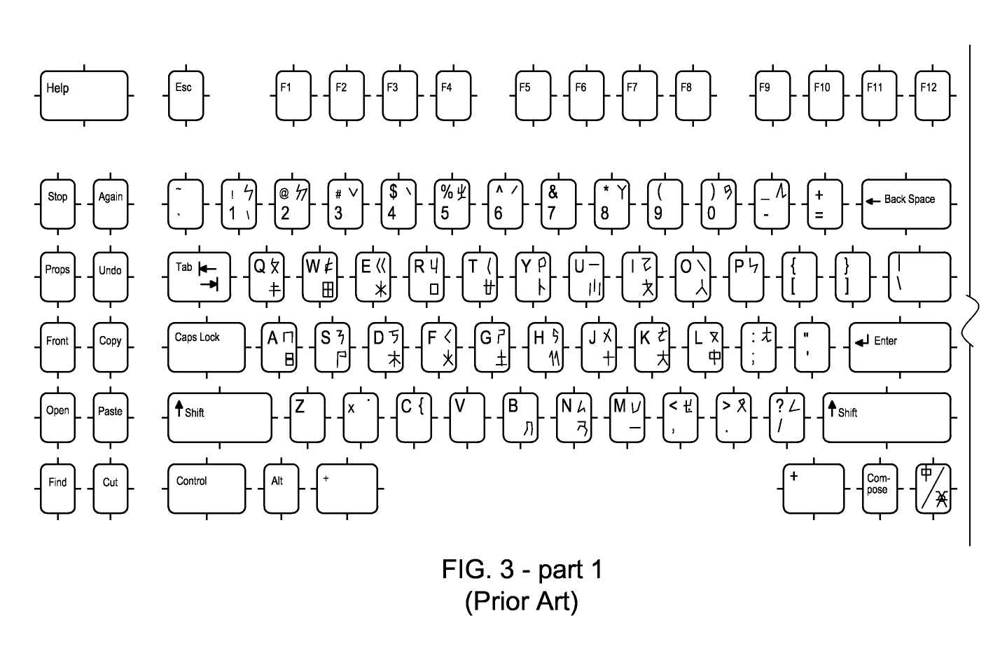

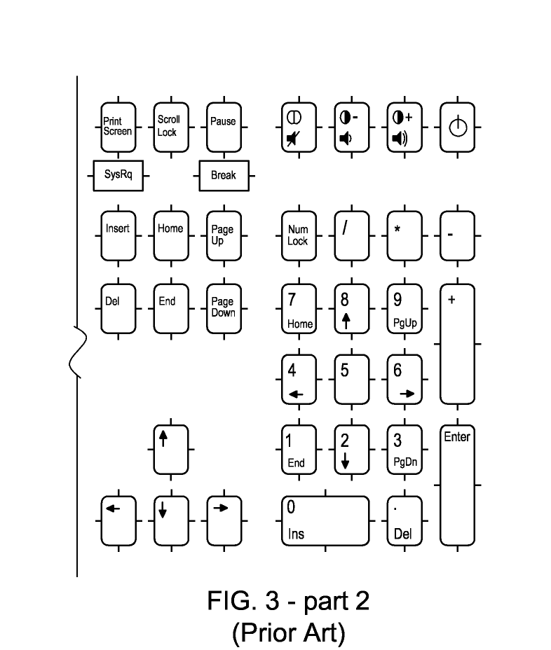

### DETAILED DESCRIPTION

The disclosure will be more completely understood through the following detailed description, which should be read in conjunction with the attached drawings. Detailed embodiments of the invention are disclosed herein, however, it is to be understood that the disclosed embodiments are merely exemplary of the disclosure, which may be embodied in various forms. Therefore, specific functional details disclosed herein are not to be interpreted as limiting, but merely as a basis for the claims and as a representative basis for teaching one practiced in the field to variously employ the disclosure in virtually any appropriately detailed embodiment.

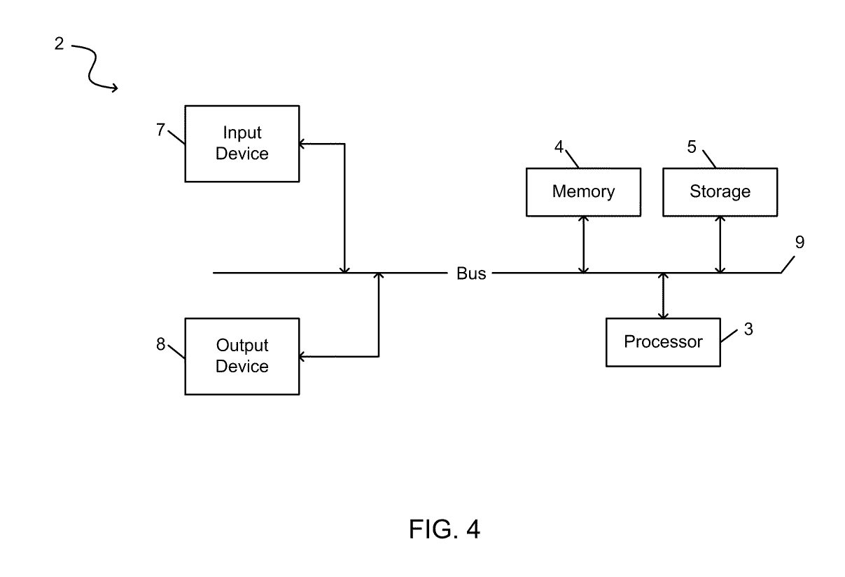

FIG. 4 is a functional block diagram that illustrates the components of an exemplary computing device 2 for practicing an embodiment of the disclosure. A computing device 2 preferably includes a processing unit or processor 3, a system memory 4, a disk storage 5, an input device 7, an output device 8, and a system bus 9. System bus 9 couples system components including, but not limited to, system memory 4 to processing unit 3. The processing unit 3 can be any of various available processors.

Input device 7 may be a keyboard, thumbboard, camera, touch-screen (for use with a stylus or by hand), or any other suitable input device known to those of skill in the art, that are used to receive data from a user. In addition, input device 7 can also include a plurality of other inputs or controls for adjusting and configuring one or more aspects of the present disclosure including voice commands. Output device 8 may be a display device, such as an LCD or LED display screen, projector, or any other suitable display device known to those of skill in the art, that can display one or more display objects (not shown) such as configurable icons, buttons, input boxes, menus, tabs, key labels and so forth having multiple configurable dimensions, shapes, colors, text, data and sounds to facilitate operations with computing device 2.

Storage 5 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (“EEPROM”), magnetic disk storage or other magnetic storage devices, or any other medium that can be used to store digital information on a mobile device.

The system 2 of FIG. 4 may include software that acts as an intermediary between users and the basic resources described in computing device 2. Such software preferably includes an operating system. The operating system, which can be resident in storage 5, acts to control and allocate resources of computing device 2. System applications take advantage of the management of resources by the operating system through program modules and program data stored either in system memory 4 or on disk storage 5. Furthermore, embodiments of the disclosure can be implemented with various operating systems or combinations of operating systems.

The computer readable medium tangibly embodies a program, functions, and/or instructions that cause the computer system to operate in a specific and predefined manner as described herein. Those skilled in the art will appreciate, however, that the process described below relating to the input device and application development, as well as other features recited herein, may be implemented at any level, ranging from hardware to application software and in any appropriate physical location. For example, the present disclosure may be implemented as software code to be executed by computing device using any suitable computer language and may be stored on any of the storage media described above, or can be configured into the logic of input device 7. Such software code may be executed by using any suitable computer language such as, for example, Java, Javascript, C++, C, C#, Perl, Visual Basic, Transact/Structure Query Language (T/SQL), database languages, assembly, microcode, and/or other languages and tools, as well as various system-level SDKs.

According to one embodiment of the disclosure, a reconfigurable keyboard includes re-assignable key-mappings and a choice of several languages that can be changed in real-time without reconfiguring the operating system or word processing program. The reconfigurable keyboard may include a touch-sensitive display that presents a digital keyboard layout that can be customized by the typist to provide a keyboard configuration that is the most efficient, logical and intuitive to the typist. The keyboard layout may be displayed as a graphical user interface (GUI) on dynamic keyboard having a plurality of input icons corresponding to characters of at least one alphabet, so that a user can interact with the one or more displayed alphabets. The term alphabet as used herein includes symbols and characters corresponding to letters, numbers, punctuation, diacritics, equation, formulas, GUI functions, and any other suitable symbols and characters known to those of skill in the art. Pressing on a touch sensitive input where the key is displayed sends the character displayed on the key to the processor, such as processor 3 of system 2, and is then displayed on the typist's primary display. A drop-down menu, or other type of menu, may be shown on the digital keyboard screen allowing the typist to select another language or keyboard layout, thereby seamlessly transforming the keyboard to display the alphabet of one or more languages in a customized format.

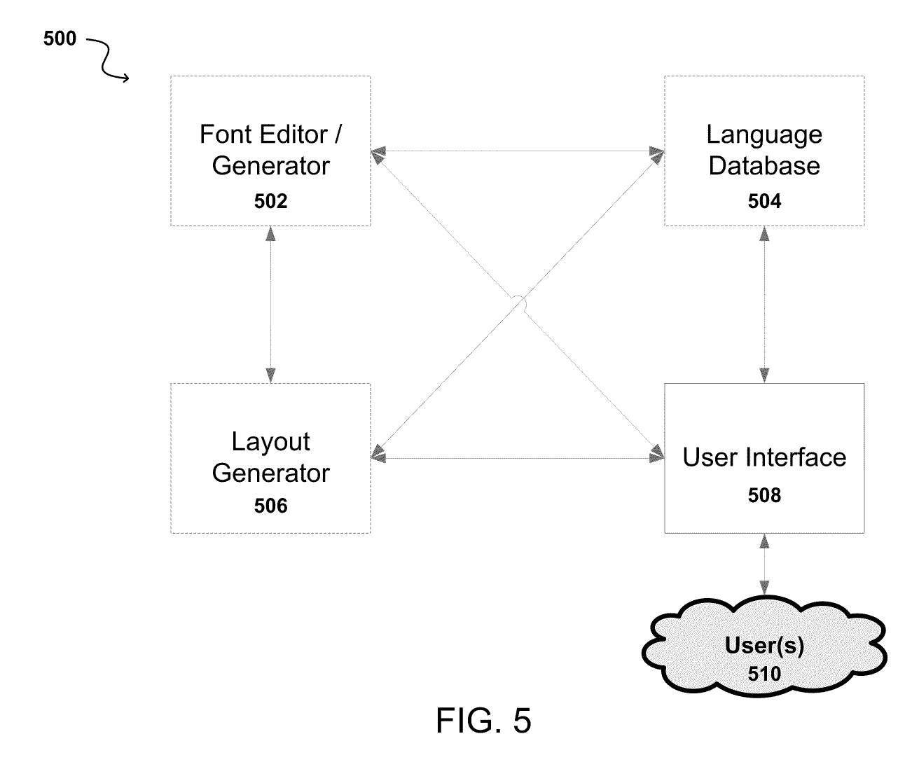

FIG. 5 is a block diagram of the components of a configurable keyboard system 500 in accordance with an embodiment. The configurable keyboard system 500 may be operated in connection with the computing system 2 of FIG. 4. The components of the configurable keyboard system 500 may be implemented in software stored on storage 5 and/or system memory 4, and executed by processor 3 of computing system 2. The configurable keyboard system 500 includes Font Editor/Generator 502, Language Database 504, Layout Generator 506 and User Interface 508. Each component may be connected to one or more processors for executing the instructions stored in a local memory or received from another component. While the embodiment shown in FIG. 5 depicts separate physical components of the system, each component may be implemented in one physical structure with each system defined by a logical architecture.

The Font Editor/Generator 502, Language Database 504 and Layout Generator 506 may be stored as software components on system 2. In certain embodiments, one or more of the Font Editor/Generator 502, Language Database 504 and Layout Generator 506 may be stored as software components directly on a hardware component of the User Interface 508. The configurable keyboard system 500 may be connected to one or more users 510 through the User Interface 508. Each component of the configurable keyboard system 500 is configured to communicate with each other component in the system. In certain embodiments, a user may interact with and control one or more components of the configurable keyboard system 500 through User Interface 508. In certain embodiments, an external computing device may be used to interact with and control the components of configurable keyboard system 500. For example, the configurable keyboard system 500 may be connected to a computing system, such as computing system 2 of FIG. 4, through User Interface 508, or any other suitable connection means known to those of skill in the art.

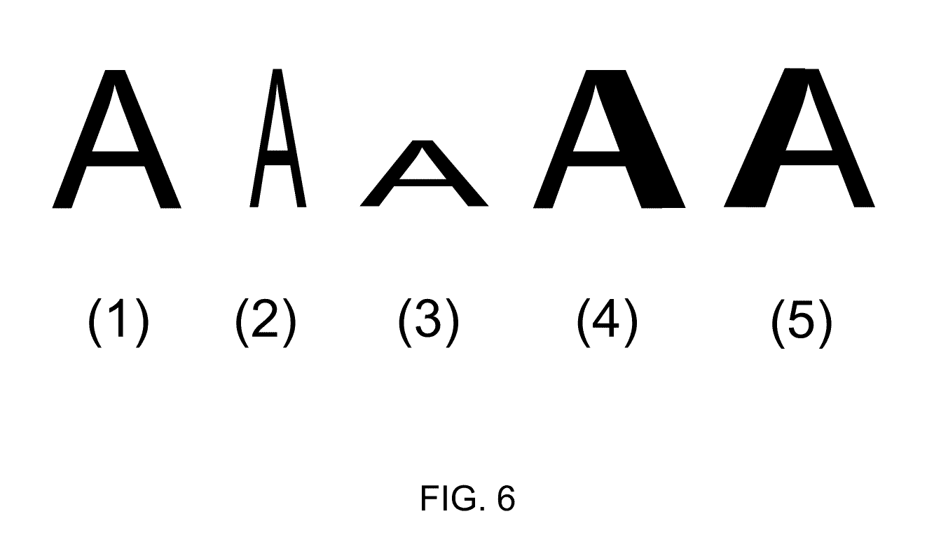

According to an embodiment, a Font Editor/Generator 502 is included in system 500 to create, design and alter individual characters or symbols of an alphabet. The application code for the font editor may be stored on a local storage included in the User Interface 508, and run on a touch-sensitive display, or it may be stored on a personal computer storage, such as storage 5, and run on the primary display. The font editor is configured to import a standard font via an input connection such as a USB port, an internet connection, or any other suitable network connection known to those of skill in the art, or a font may be scanned in from a hardcopy sheet using a scanner and optical character recognition (“OCR”) application. The Font Editor/Generator 502 allows a user to customize or create characters to, for example, provide an alternative phonetic representation of a character without the use of diacritics. For example, as shown in FIG. 6(1)-(5), variations of the letter ‘A’ may be created to highlight or distinguish the pronunciation of the letter. A normal representation of the letter ‘A’ may indicate a certain pronunciation, while a narrower character, (2), may indicate a different pronunciation or emphasis. With the use of the Font Editor 502, any character in any language may be modified or adapted to the typist's preferences or used in an effort to educate a student in learning a new language. The Font Editor/Generator 502 provides a tool for font design and redefinition management. As explained below in greater detail, the new font or alphabet may be mapped or grouped with other languages' alphabets in order to assist in teaching or leaning a new language.

The Language Database 504 may be used to store the fonts of a defined spoken language. Fonts representing different languages may be stored and arranged in the Language Database 504 such that upon receiving an instruction from the Font Editor/Generator 502 to load a font set, a processor may easily locate and retrieve the data associated with that language. For example, if a user desired to use an English language font as a basis for generating her own characters and symbols, upon receiving a load instruction from the Font Editor 502, the Language Database 504 would retrieve and output the chosen font and any data associated with the font to the Font Editor 502. The Font Editor 502 may display the font to a user 510 through User Interface 508 or through an external display device, such as the primary display of a computing device. The user may then alter and change the characters of the font to her liking using the Font Editor 502, and save the edited font in the Language Database 504 as a new unique alphabet. The user may then recall or load the unique alphabet from the Language Database 504 at any later time.

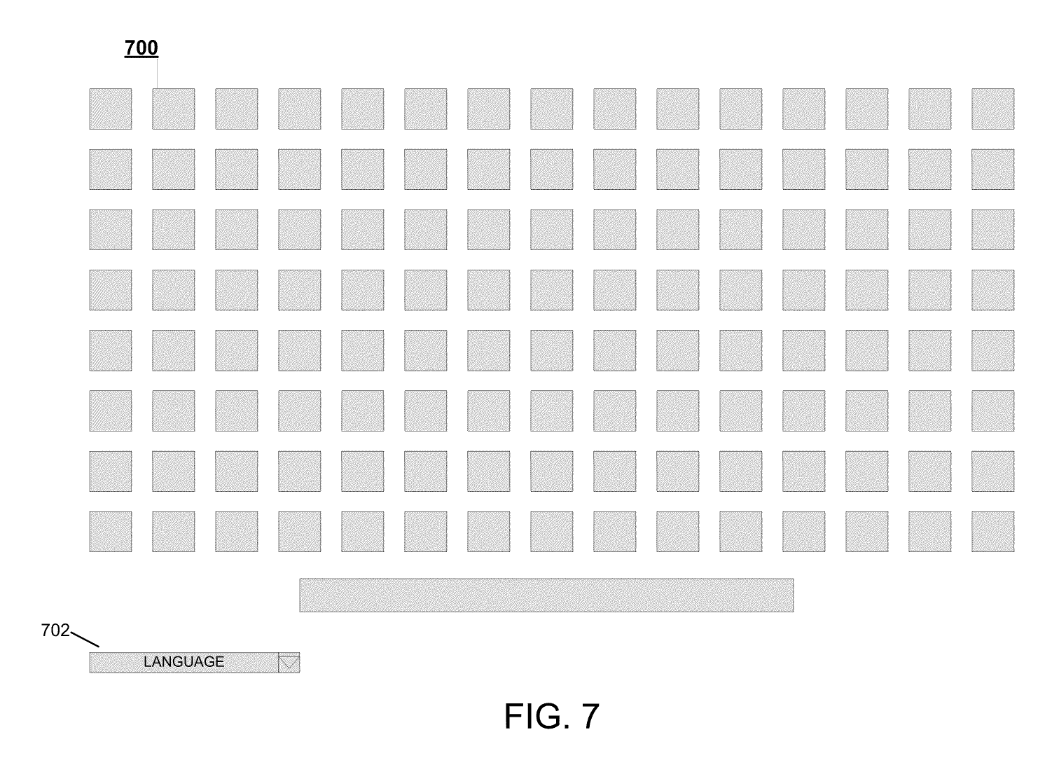

The Layout Generator 506 of system 500 may load the characters from the loaded alphabet or font set in a customized manner as defined by a user. According to an embodiment, the Layout Generator 506 generates a dynamic and reconfigurable keyboard layout such that the layout is not constrained by size or number of keys. The layout provides a keyboard configuration that will display as many keys and characters as necessary to accommodate the alphabet or characters chosen. FIG. 7 depicts an example of a dynamic keyboard layout 700 generated by the Layout Generator 506 in accordance with an embodiment. Each of the keys may be displayed as an icon or image. The icons may be linked to one or more characters or symbols. The one or more icons corresponding to one or more characters may be displayed as a keyboard layout on User Interface 508. FIG. 7 depicts a dynamic keyboard layout 700 before any alphabet or customized keyboard configuration has been selected.

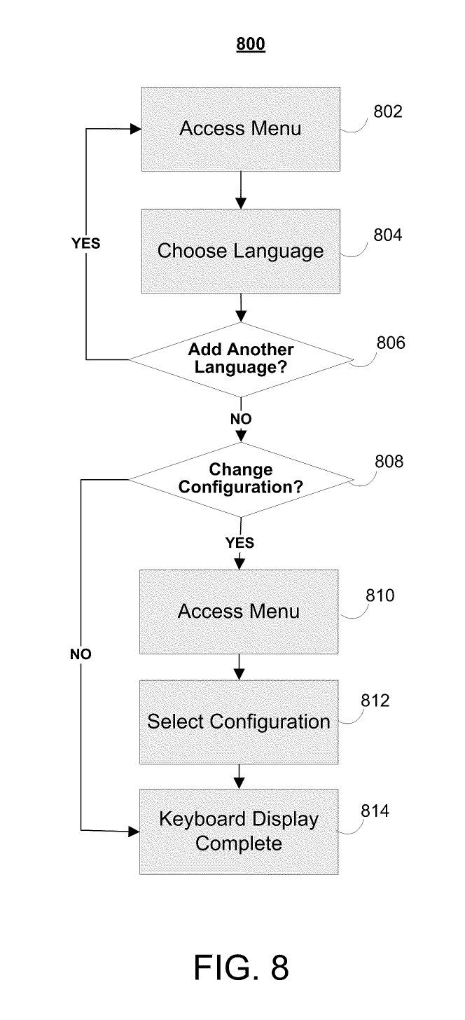

A typist, according to one embodiment, may configure a customized keyboard layout, such as the layout shown in FIG. 7, in accordance with the steps of FIG. 8. FIG. 8 shows a flow chart for configuring a keyboard display layout, according to an illustrative embodiment. In step 802, a user may access a list of available languages stored in the Language Database 504 from the menu 702, shown in the lower-left portion of the display 700. While only one menu 702 is shown in display 700, in certain embodiments the keyboard display may include 2 or more menus. For example, one menu may include languages, and another menu may include keyboard configurations. In step 804, the user may select one or more languages or alphabets corresponding to a language from the menu 702. Once an alphabet corresponding to a language is selected, the keys of the dynamic keyboard display may transform into a keyboard configuration including the language alphabet. For example, selecting “English” from the menu would transform the first row of the keyboard into an English language keyboard. At step 806, a user may decide to add another language to the dynamic keyboard display. For example, if a user decides to select another language from the menu 702, the language may be added to the next available row in the dynamic keyboard display. The steps 802-806 may be repeated as many times as necessary until the desired number of languages and/or alphabets have been added to the dynamic keyboard display. In step 808, a user may choose to change the configuration of the keyboard layout. For example the user may change the key positions, key sizes, key color, number of characters on a key, character sound, or anything suitable aspect of the keyboard layout. In certain embodiments, the menu 702 may be used to select a customized keyboard configuration that has been previously stored in memory. In step 810, a user may access the menu 702 to select a pre-saved configuration, and may select the desired configuration in step 812. In certain embodiments, one or more keyboard configurations may be layered on top of each other. This may help conserve real estate on the keyboard display. For example, a first keyboard layout having a first group of characters may be overlap or partially overlap a second keyboard layout having a second group of characters. In certain embodiments, a user may turn ‘on’ or ‘off’ one or more layers as desired. It will be understood by those of skill in the art that the steps of process 800 may be carried out in an order other that depicted in FIG. 8. For example, a user may select a keyboard configuration before selecting one or more languages. In certain embodiments, a keyboard configuration may not be selected at all. Once one or more languages have been selected and optionally a keyboard configuration is selected, the keyboard display is completed in step 814 and the keys may transform into a corresponding keyboard configuration including one or more selected language alphabets.

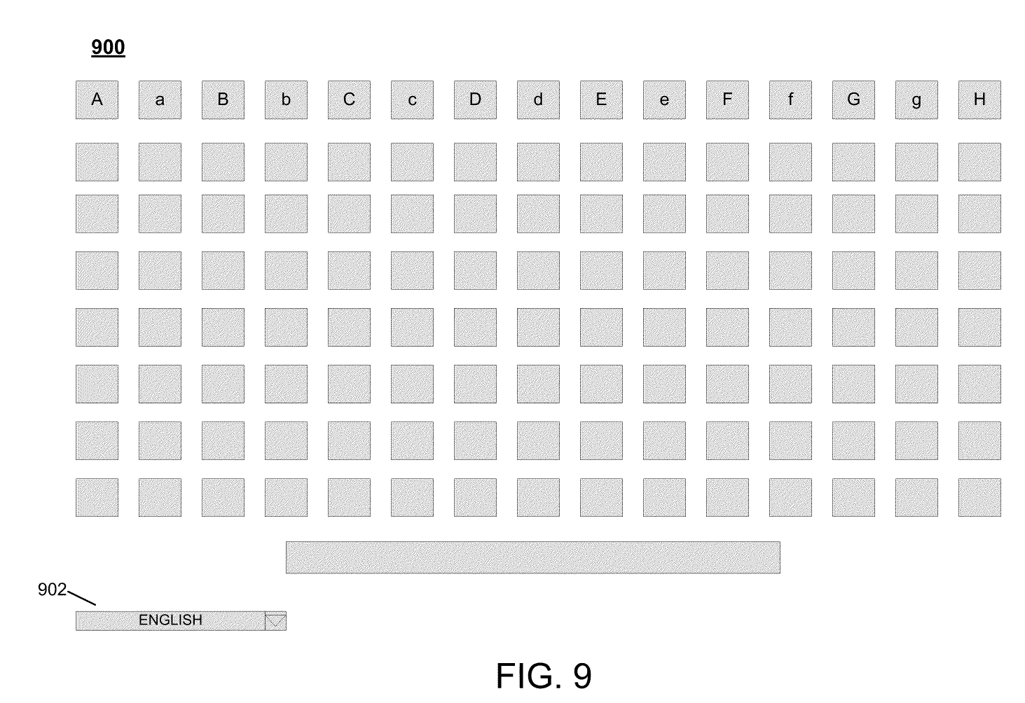

For example, a portion of an illustrative English configuration is depicted in FIG. 9. The keyboard is customizable so the typist is not constrained to the QWERTY configuration of the keys. The keyboard may be laid out in alphabetic order, for example, starting with the letter ‘a’ and moving to the right, alphabetically. Additionally, according to one embodiment, different variations of base characters may be displayed in neighboring keys. For example, the upper-left most key may be a lowercase ‘a’ followed by the capital ‘A’ to the right, followed by the lowercase ‘b’ and uppercase ‘B’ to the right of that. One skilled in the art should recognize that all possible characters in the English language are not shown in the example of FIG. 9 and that FIG. 9, for the sake of brevity and clarity, is provided as a sample of an entire keyboard configuration. In an alternative embodiment, accented or modified characters may be displayed in sequence with the base characters (e.g., a sequence of neighboring keys as: ‘A,’ ‘a,’‘á,’ ‘à,’ . . . ‘B’, ‘b,’ etc.). In certain embodiments, pressing a key twice may alternate it between upper case and lower case letters. For example, pressing a key labeled ‘A’ twice in succession may cause it to display ‘a’. The keyboard may use only the appropriate number of keys required to sufficiently and effectively display the characters of a given language.

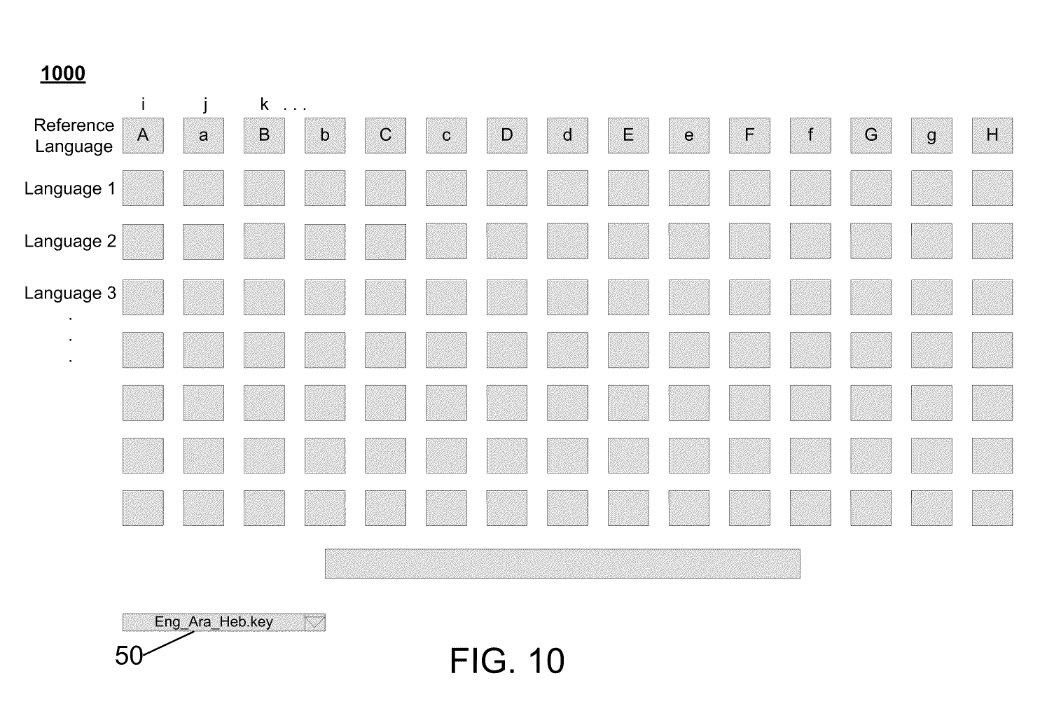

In certain embodiments, multiple languages may be selected using the process 800 and displayed in corresponding icons in different rows of the keyboard display. FIG. 10 depicts a portion of a keybaord display in which the first row contains, for example, English language characters as the references, and subsequent rows contain characters of one or more other languages. Similarly to the selection of an English only keyboard, the languages may be sequentially chosen from the menu 1002 and the keyboard keys are seamlessly transformed into characters representing the alphabets on the display. In certain embodiment, a keyboard configuration including all of the languages in the desired layout may be previously saved to the Language Database 504. This pre-saved configuration may be selected from menu 1002. As shown in FIG. 10, multiple languages (i.e., Language 1, Language 2, etc.) may be placed in rows beneath the Reference Language. Characters from each language having similar phonetics or pronunciations may be placed in the same column (i, j, k, etc.). In certain embodiments, after selecting one or more languages, the characters having similar phonetics may be automatically grouped in the same column. One skilled in the art should recognize that all possible characters in the alphabets are not shown in the example of FIG. 10 and that FIG. 10, for the sake of brevity and clarity, is provided as a sample of the entire keyboard configuration.

In certain embodiments, the arrangement of characters is not dictated by a rigid and archaic mapping to the QWERTY configuration. Using the Layout Generator 506, the keys may be selected and arranged in a manner most effective and intuitive to the typist, taking up only the number of keys required to sufficiently represent the language's alphabet. In one embodiment the characters may be grouped vertically across several languages based on phonetic characteristics. For example, a hard “c” sound is represented in the English language by the letter “c” or “k”, while in another language the sound may be represented by another character. As a way to help learn the phonetic aspects of different languages, the characters representing these sounds may be grouped phonetically so that someone using the display or keyboard, as detailed below, would learn what characters in other languages correspond to the hard “c” sound in English. In certain embodiments, when a user selects a particular character, the phonetic sound of that character may be audibly played to the user.

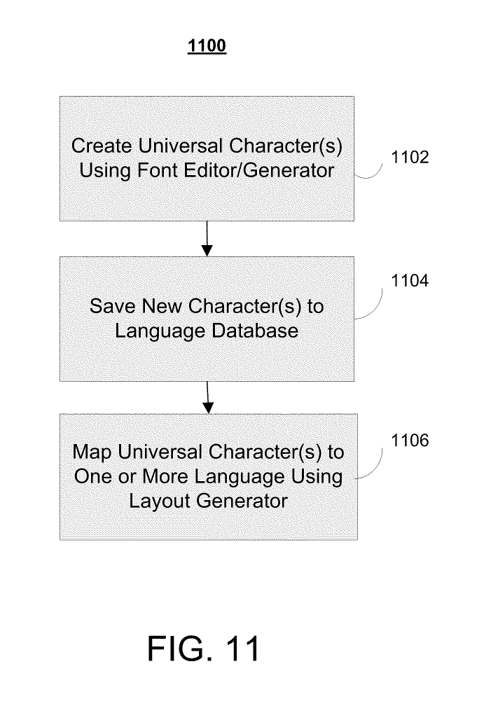

According to another embodiment, the ability to group phonetic sounds as characters can bring a linguist closer to a universal alphabet. FIG. 11 shows a process 1100 for mapping one or more characters of a universal alphabet to the characters of one or more languages. In step 1102, a user may create one or more universal characters using the Font Editor/Generator 502. For example, as described above, a user may modify existing characters from the Language Database 504 or design one or more completely new characters. The Font Editor/Generator 502 allows for the creation of new characters that may correspond to similarities across one or more languages. The new characters may be representative of sounds and not written letters. It is known in the art that the human voice can only make a finite number of sounds. By creating a visual depiction of those sounds a user may bypass the constraints of traditional alphabets that do not have a one-to-one character mapping. For example, a user may create a new symbol for the sound made by the letters “th” in step 1102. Some alphabets across the world may have a different, single character to represent the “th” sound. In step 1104, the user may save the one or more characters created in step 1102 to the Language Database 504. Once saved in the Language Database 504, the characters may be loaded and used by any component of system 500.

In step 1106, the user may use the Layout Generator 506 to map characters from other languages that have a similar “th” sound to the newly created symbol. For example, the user may place each character corresponding to the “th” sound from one or more languages directly under the newly created symbol in the same column of the keyboard display. In certain embodiments, selecting the newly created universal character for “th” on the keyboard display, results in an output of a character corresponding to the “th” sound in one or more of the mapped languages. This may allow a user to type in one or more languages simultaneously, even though the user may not understand each of those languages. Embodiments of the disclosure assist in mapping the sounds to a language irrespective of the traditional written alphabet.

In certain embodiments, User Interface 508 includes touch-sensitive device for receiving inputs from one or more users 510, and displaying outputs to one or more users 510. The dynamic keyboard layout generated by Layout Generator 506 may be displayed on the User Interface device 508. In certain embodiments the User Interface 508 may be a touch-screen keyboard. In certain embodiment, the User Interface 508 may be hardware and software independent. For example, the User Interface 508 may include a processor and memory for storing and executing application code for each of the components of system 500. The User Interface 508 may communicate with and control the Font Editor/Generator 502, Language Database 504, and Layout Generator 506. In certain embodiments, the User Interface 508 may operate as an input device to a personal computer. The User Interface's application code may interface with the operating system of the personal computer to map the characters displayed on the keys of the dynamic keyboard display to the symbols and characters stored in the operating system's font repository. When the keyboard configuration is created and saved using the methods described above, the characters of the new font or alphabet are each associated with a unique Unicode identifier stored in a font file. When the chosen configuration is loaded, the application code for the keyboard accesses a font file containing a mapping of the Unicode identifiers to the characters. In one embodiment, if the font file is not located on the storage medium containing the operating system, a copy of the file stored on the keyboard device itself may be copied to the appropriate operating system directory in which font files are stored. For example, if the User Interface 508 is configured to display a custom language keyboard, as described above with multiple languages mapped on multiple rows, when the keyboard display configuration is loaded to the User Interface 508, the operating system looks for the appropriate font file in its repository, if it is not found, a copy of the font file is copied from the memory on the User Interface 508 device into the operating system's font repository. The operating system then loads the font file for display on the User Interface 508. When the user presses a character key on the User Interface 508, an instruction is sent to the operating system's processor to find and display the matching character from font file. The Unicode lookup is executed to find the character mapped to that code and the character is displayed to a user.

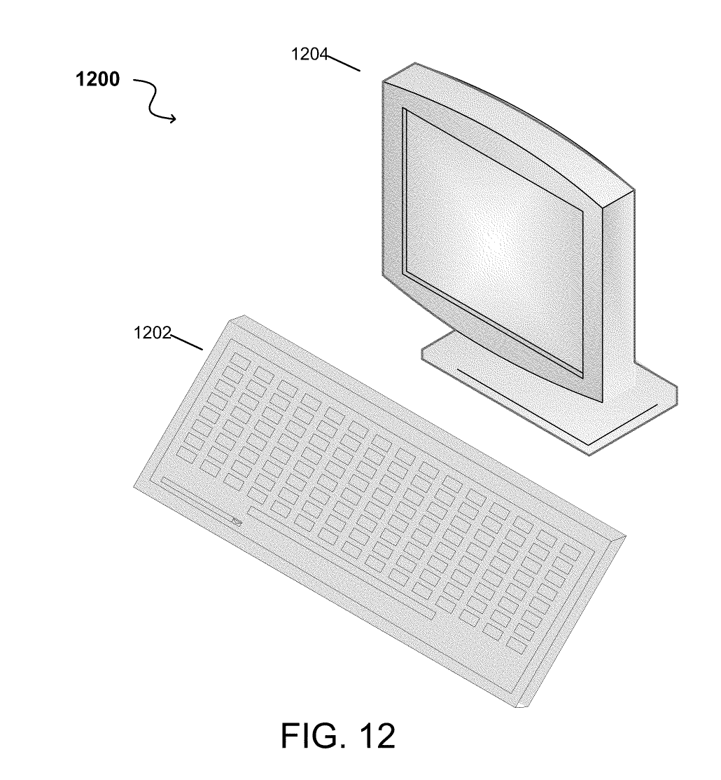

According to one embodiment of the disclosure, a touch-sensitive reconfigurable keyboard with the features described above serves as an input device to a computing device, such as a personal computer. Once a keyboard display is configured and set using the Layout Generator 506, as described above, it can be saved and loaded as a keyboard application to the User Interface 508. FIG. 12 depicts a personal computer with a touch-sensitive reconfigurable keyboard 1202 serving as the User Interface 508, and a primary display 1204. The keyboard 1202 serves as an input device to the processor of the personal computer. The keyboard 1202 may communicate with the personal computer via a wired connection, such as a USB port, or may communicate wirelessly via protocols such as Bluetooth, infrared, WiFi, etc. The keyboard 1202 may include a touch sensitive screen responsive to the touch of a finger or stylus. Application software may be stored on a storage device resident in the keyboard itself such as ROM or flash memory, or may even be stored in a storage device resident on the personal computer. The application code includes machine readable instructions for displaying the keyboard layout on the touch screen keyboard 1202, receiving the user's input of selecting a layout configuration, and transforming and redisplaying the keyboard template into the configuration of keys mapped to the characters representing the languages' alphabets. The application also provides instructions for functioning as a traditional keyboard input device. The user touches the key icon on the touch screen device 1202 and the corresponding character is then displayed on the primary display 1204. The application code further provides instructions for receiving an input from the typist to change or select another language and transform the keyboard display to a key configuration representative of the alphabet of the newly chosen language.

According to one embodiment of the disclosure, the keyboard may be used as a teaching aid or facilitation device in learning new languages. Typists may familiarize themselves with the alphabets, numbers and punctuations of foreign languages as well as practice typing in those languages. The dynamic features of keyboard also provide an ergonomic solution of typing and keyboard configuration. The keys of the keyboard are not physical or rigid and thus can be arranged and configured into convenient and ergonomic layouts.

One skilled in the art should recognize that due to the storage capacity of the memory devices included with the keyboard, any language, alphabet, character, symbol or sound may be stored, uploaded, downloaded or otherwise included into the database of available languages. Additional languages may be offered as language packs, or upgrades from a basic set of languages as well. In certain embodiments, additional keyboard layouts may be offered as layout packs, or upgrades from a basic set of layouts.

While embodiments of the disclosure described herein depict a personal computer with a separate keyboard device, one skilled in the art should recognize that the keyboard may be implemented within a single enclosure with the computing device. Further, while embodiments described herein depict a personal computer with a reconfigurable keyboard, one skilled in the art should recognize that other devices relying on user input may be implemented, such as mobile telephones, PDAs, laptop computers, etc., without deviating from the scope of the disclosure.

While the disclosure has been described with reference to illustrative embodiments, it will be understood by those practiced in the field that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A user interactive touch-screen keyboard device comprising:
a plurality of icons in a plurality of rows and columns,
a plurality of characters from at least two user-selected languages, wherein the plurality of characters from the at least two user-selected languages are assigned to the plurality of icons in respective ones of the plurality of rows in a first order characteristic of the respective language, and
a user controlled processor for creating a reordering of the characters of at least one said language for grouping characters of at least two languages according to a desired grouping methodology.

2. The device of claim 1, further comprising a multi-layer system for displaying the at least two user-selected languages in at least two layers.

3. The device of claim 2, wherein the at least two layers at least partially overlap.

4. The device of claim 1, wherein one of the rows has characters defined by a user.

5. The device of claim 4, wherein the characters are modified from pre-existing characters by the user.

6. The device of claim 4, wherein the characters are created as new characters by the user.

7. The device of claim 1, wherein selecting a language places one or more characters of the selected language in the next available row.

8. The device of claim 1, wherein selecting a language places one or more characters of the selected language in the next available column.

9. The device of claim 1, further comprising a menu for selecting the at least two user-selected languages.

10. A configurable keyboard system comprising;
a user interface for receiving inputs from a user;
a language database for storing at least partial alphabets of at least two languages;
a layout generator for generating a configurable keyboard for display on the user interface, wherein the layout generator is responsive to user inputs for generating a phonetically grouped character representation of the alphabets of the at least two languages; and
a processor configured to execute operating instructions for the user interface, layout generator, and the language database.

11. The system of claim 10, further comprising a font generator for generating and modifying at least one character.

12. The system of claim 10, wherein the user interface is a touch-sensitive device capable of receiving inputs and displaying outputs.

13. The system of claim 10, wherein the configurable keyboard includes a plurality of icons corresponding to characters of the at least one alphabet.

14. The system of claim 13, wherein the processor is further configured to:
receive a selection of an icon on the user interface; and
display the character corresponding to the selected icon on a display.

15. The system of claim 10, wherein the configurable keyboard is a graphical user interface.

16. A method for configuring a keyboard comprising;
accessing a menu including a list of languages;
selecting a first language to be learned from the menu;
assigning characters from the first language to one or more icons representing a keyboard;
selecting a second language known to a user from the menu; and
assigning characters of the second language automatically to one or more icons in phonetic proximity with corresponding phonetic characters of the first language.

17. The method of claim 16, further comprising displaying the characters of the first and second languages in a keyboard display on a touch-sensitive device.

18. The method of claim 17, further comprising:
accessing a menu including a list of at least one keyboard configuration;
selecting a keyboard configuration from the menu;
reconfiguring the keyboard display in accordance with the selected keyboard configuration; and
displaying the keyboard display on the touch-sensitive device.

19. The method of claim 16, wherein assigning characters from the first language to the one or more icons representing a keyboard includes assigning the characters from the first language to a first row of the keyboard display.

20. The method of claim 18, further comprising generating at least one user-defined character, wherein the user defined character is accessed from the menu.

21. A method for configuring a keyboard for improved language learning presentation comprising;
accessing a menu including a list of languages;
selecting a first language to be learned from the menu;
assigning characters of the first language to icons representing a keyboard; selecting a second language known to a user from the menu, and
selecting characters of the second language automatically in phonetic proximity with corresponding phonetic characters of the first language.

22. A touch-screen keyboard device comprising
a plurality of icons in a plurality of rows;
a plurality of characters from at least two user-selected languages wherein the plurality of characters are associated with the plurality of icons in a user selected representation, the representation comprising characters from both languages, and
a user controlled menu for selecting the language combination.

23. A configurable keyboard device comprising:
means for receiving at least one input from a user;
means for storing at least partial alphabets of at least two languages; and
means for displaying a configurable keyboard layout including the alphabets of the at least two languages in response to the at least one input.

24. A touch-screen keyboard system comprising:
a processor for implementing a sequence of instructions stored on a computer readable medium and configured to perform the steps of
(a) receiving a user input for selecting a plurality of characters from at least two languages;
(b) grouping the plurality of characters according to a grouping methodology; and
(c) displaying the plurality of characters on a touch screen.

25. The system of claim 24, wherein the processor is further configured to:
receive a user-selection of at least one of the plurality of characters on the touch screen; and
display the selected character on a primary display.
